(19) United States
(12) Patent Application Publication
(10) Pub. No.: US 2004/0105992 A1
(43) Pub. Date: Jun. 3, 2004

(54) Sparkling laminate film and sparkling shaped article

(76) Inventors: Sei-No-Suke Mizuno, Tokyo (JP); Yoshikazu Satoh, Saitama (JP); Masahiro Nakai, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/720,165

(22) Filed: Nov. 25, 2003

(30) Foreign Application Priority Data
Nov. 29, 2002 (JP) JP2002-347034

(51) Int. Cl. B32B 1/00

(52) U.S. Cl. 428/480; 428/606

(57) ABSTRACT

A novel sparkling laminate film high in bonding strength between a transparent surface substrate and metal vapor deposited layer and not easily peeling even with long term use while maintaining a superior metallic gloss, including a transparent surface substrate, a metal vapor deposited layer comprised of a vapor deposited layer of a Hastelloy alloy and a vapor deposited layer of chromium or chromium alloy, titanium or titanium alloy, or nickel or nickel alloy successively formed on a back surface of the transparent surface substrate, and a backing material integrally laminated with the metal vapor deposited layer through an adhesive layer, and a sparkling shaped article using the same.

### BACKGROUND OF THE INVENTION

1. Field of the Invention

The present invention relates to a sparkling film and sparkling shaped article for decorative use having a metallic gloss to be used for an automobile molding etc.

2. Description of the Related Art

Extensive use is being made of moldings of automobiles, for example, having decorative laminate films giving a metallic gloss bonded on their surfaces. As such a laminate film, there has been known a film obtained by forming a metal vapor deposited layer on the back surface of a transparent surface substrate by sputtering of aluminum, chromium, or an alloy of the same and integrally laminating a packing material on the back surface of that metal vapor deposited layer through an adhesive layer (for example, see Japanese Utility Model Publication (A) No. 59-135257, p. 3 to 5, FIG. 2).

However, with such a type of sparkling laminate film formed with a metal vapor deposited layer, if using this over a long period of time integrally bonded to the surface of an automobile molding or other shaped article, sometimes peeling will occur between the transparent surface substrate and the metal vapor deposited layer.

### SUMMARY OF THE INVENTION

An object of the present invention is to provide a novel sparkling laminate film and sparkling shaped article high in bonding strength between a transparent surface substrate and metal vapor deposited layer and not easily peeling even with long term use while maintaining a superior metallic gloss.

To attain the above object, according to a first aspect of the present invention, there is provided a sparkling laminate film comprised of a transparent surface substrate, a metal vapor deposited layer comprised of a vapor deposited layer of a Hastelloy alloy and a vapor deposited layer of chromium or chromium alloy successively formed on a back surface of the transparent surface substrate, and a backing material integrally laminated with the metal vapor deposited layer through an adhesive layer.

According to a second aspect of the present invention, there is provided a sparkling laminate film comprised of a transparent surface substrate, a metal vapor deposited layer comprised of a vapor deposited layer of a Hastelloy alloy and a vapor deposited layer of titanium or titanium alloy successively formed on a back surface of the transparent surface substrate, and a backing material integrally laminated with the metal vapor deposited layer through an adhesive layer.

According to a third aspect of the present invention, there is provided a sparkling laminate film comprised of a transparent surface substrate, a metal vapor deposited layer comprised of a vapor deposited layer of a Hastelloy alloy and a vapor deposited layer of nickel or nickel alloy successively formed on a back surface of the transparent surface substrate, and a backing material integrally laminated with the metal vapor deposited layer through an adhesive layer.

Preferably, in each of the above aspects, the metal vapor deposited layer has a thickness of 150 to 750 Å.

More preferably, in each of the above aspects, a hue angle (H°) when measuring the color of the transparent surface substrate is in a range of 245 to 265.

Still more preferably, in each of the above aspects, the transparent surface substrate is a fluorine- or polyester-based film of a thickness of 15 to 100 μm.

According to a fourth aspect of the present invention, there is provided a sparkling shaped article comprised of a shaped body and any of the above sparkling laminate films integrally bonded to a surface of that body.

### BRIEF DESCRIPTION OF THE DRAWINGS

These and other objects and features of the present invention will become clearer from the following description of the preferred embodiments given with reference to the attached drawings, wherein:

FIG. 1 is a schematic sectional view of a sparkling laminate film according to an embodiment of the present invention;

FIG. 2 is a view of the step of forming a metal vapor deposited layer;

FIG. 3 is a sectional view of a step of vapor deposition of a Hastelloy alloy;

FIG. 4 is a sectional view of a step of vapor deposition of chromium or chromium alloy (titanium or titanium alloy or nickel or nickel alloy); and

FIG. 5 is a sectional view of an example of a sparkling shaped article.

### DESCRIPTION OF THE PREFERRED EMBODIMENTS

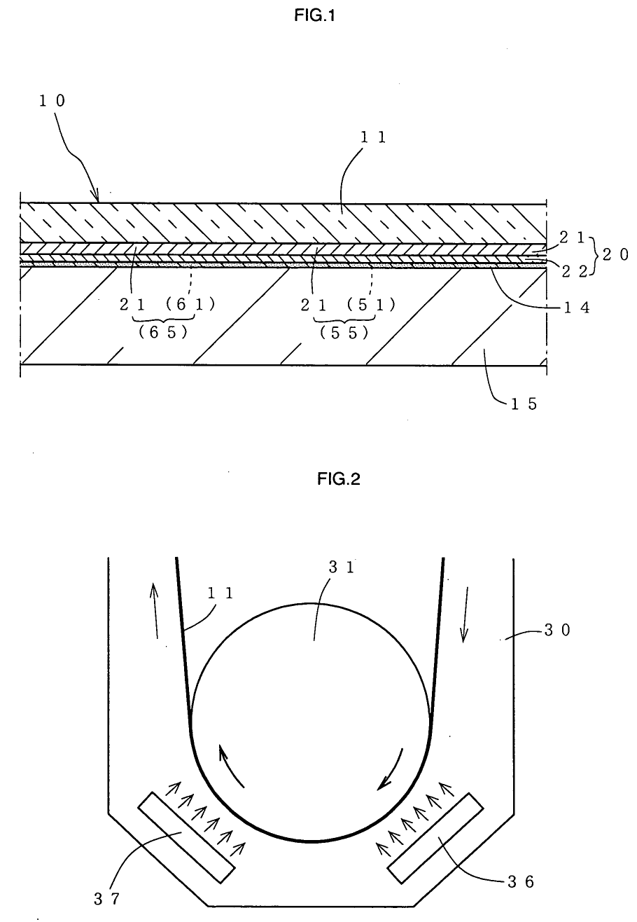

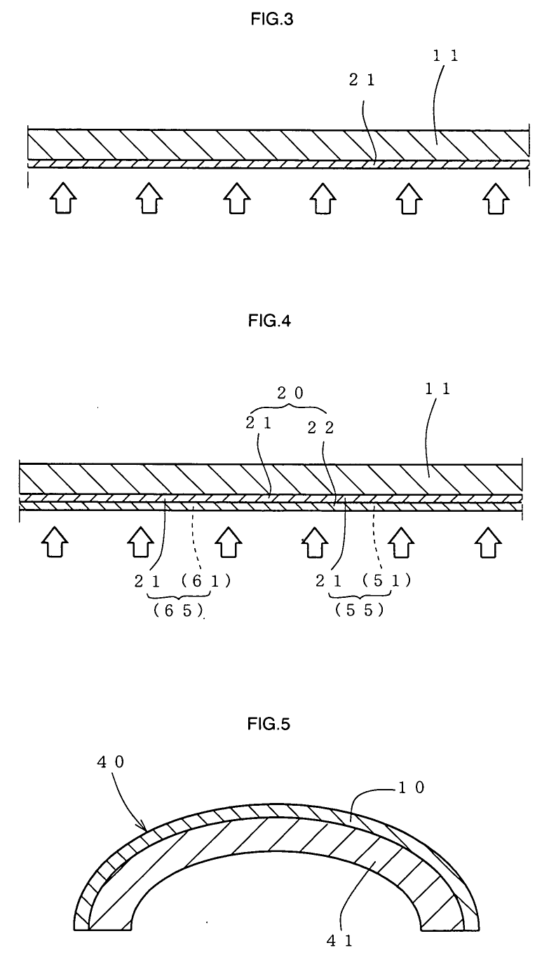

Preferred embodiments of the present invention will be described in detail below while referring to the attached figures. FIG. 1 is a schematic sectional view of a sparkling laminate film according to an embodiment of the present invention; FIG. 2 is a view of the step of forming a metal vapor deposited layer; FIG. 3 is a sectional view of a step of vapor deposition of a Hastelloy alloy; FIG. 4 is a sectional view of a step of vapor deposition of chromium or chromium alloy (titanium or titanium alloy or nickel or nickel alloy); and FIG. 5 is a sectional view of an example of a sparkling shaped article.

As shown in FIG. 1, the sparkling laminate film 10 according to the present invention is comprised of a transparent surface substrate 11, a metal vapor deposited layer 20 comprised of a vapor deposited layer 21 of a Hastelloy alloy and a vapor deposited layer 22 of chromium or chromium alloy (titanium or titanium alloy or nickel or nickel alloy) successively formed on a back surface of the transparent surface substrate 11, and a backing material 15 integrally laminated with the metal vapor deposited layer 20 through an adhesive layer 14.

The transparent surface substrate 11 forms the topmost layer of the sparkling laminate film 10 and expresses at its outer surface the metallic gloss due to the metal vapor deposited layer 20 formed at its back surface. The transparent surface substrate 11 is for example comprised of a polyester-based resin and may also include a polyethylene terephthalate, polybutylene terephthalate, or other aromatic polyester resin and copolymer ingredients. Note that a fluororesin, an acryl-based resin, a polycarbonate, or other resin may also be used. The metal vapor deposition side may be primed. Note that when weathering resistance is sought, the ΔE of the color difference due to 2000 hours of treatment of the substrate alone by a sunshine weather meter is preferably within at least 3.

The transparent surface substrate 11 is preferably a fluorine- or polyester-based film with a high weathering resistance and having a thickness of 15 to 100 μm, particularly preferably 25 to 75 μm. If too thin, the weathering resistance and other facets of its performance will become a problem, while if too thick, there will be problems in terms of cost.

The metal vapor deposited layer 20 is comprised of a vapor deposited layer 21 of a Hastelloy alloy and a vapor deposited layer 22 of chromium or a chromium alloy (titanium or titanium alloy or nickel or nickel alloy) successively formed on the back surface of the transparent surface substrate 11. The metal vapor deposited layer 20 may be formed by known sputtering, electron beam deposition, ion plating, or another suitably selected physical film-forming method. In this embodiment, DC magnetron sputtering shown in FIG. 2 was used. Note that as the Hastelloy alloy, for example, C-22 may be mentioned. A Hastelloy alloy is generally known to be superior in corrosion resistance, weathering resistance, water-proofness, heat resistance, etc. As the chromium or chromium alloy (titanium or titanium alloy or nickel or nickel alloy) or aluminum, a known one may be used.

FIG. 2 is a conceptual view of a vapor deposition apparatus using the above DC magnetron sputtering method. Reference numeral 30 indicates a vacuum chamber and 31 a cleaning roll. The transparent surface substrate 11 runs in the arrow direction. The transparent surface substrate 11 is held by a dry roll 31 and formed with a vapor deposited layer 21 of a Hastelloy alloy by a target 36 of a Hastelloy alloy, then the Hastelloy alloy vapor deposited layer 21 is successively continuously formed with a vapor deposited layer 22 of chromium or chromium alloy (titanium or titanium alloy or nickel or nickel alloy) by a target 37 of chromium or chromium alloy (titanium or titanium alloy or nickel or nickel alloy), whereby the metal vapor deposited layer 20 is formed.

By successively continuously forming the vapor deposited layer 22 of chromium or chromium alloy (titanium or titanium alloy or nickel or nickel alloy) on the Hastelloy alloy vapor deposited layer 21 in a single vapor deposition apparatus in this way, the strength of the metal vapor deposited layer 20 can be greatly improved, even at the same thickness, over a vapor deposited layer of a Hastelloy alloy or chromium or chromium alloy (titanium or titanium alloy or nickel or nickel alloy) alone. In this example, the Hastelloy alloy vapor deposited layer has a thickness of 50 to 100 Å, while the chromium or chromium alloy (titanium or titanium alloy or nickel or nickel alloy) vapor deposited layer 22 has a thickness of 150 to 200 Å.

The metal vapor deposited layer 20 preferably has a thickness in the range of 150 to 750 Å, particularly 200 to 500 Å. If more than 750 Å, the metal vapor deposited layer easily cracks—which is unpreferable in terms of appearance, production, and cost, while if less than 150 Å, the targeted metal sparkling nature falls.

The adhesive layer 14 bonds the metal vapor deposited layer 20 and the backing material 15 and can be coated by a dry laminator. The adhesive is a binary curing type polyurethane-based adhesive etc. applied as necessary. The thickness after coating and drying is 1 to 10 μm, more preferably 2 to 7 μm. If less than 1 μm, a satisfactory bonding strength cannot be obtained, while if over 10 μm, there are problems from the viewpoint of production and cost.

The backing material 15 is selected in material, thickness, etc. in relation to the other material which the sparkling laminate film 10 of the present invention is to be bonded to with or cover. For example, when the sparkling laminate film 10 of the present invention is to be formed integrally with an article formed by extruding a polyvinyl chloride resin, a polyvinyl chloride resin film is preferably used as this backing material 15. As a general material, for example, among polyolefin-based resins, a polypropylene resin and a resin containing copolymer ingredient may be used. In addition, an ABS resin etc. may be used as the polymer alloy resin. As the required performance, heat resistance, water-proofness, etc. are required, so a heat resistance stabilizer etc. may also be contained.

The backing material has a thickness of 30 to 500 μm, preferably 50 to 300 μm. If under 30 μm, the bonding performance is not satisfactory, while if over 500 μm, there are disadvantages in terms of production and cost. Further, the back surface of the backing material (side opposite to metal vapor deposited layer 20) may be primed to improve its bondability with a material used in later processing.

In the sparkling laminate film 10 of the present invention, one having a hue angle (H°) of a color and color difference meter L*C*H° color mode of a color difference meter when measuring the color of the transparent surface substrate 11 in the range of 245 to 265, preferably in the range of 250 to 260, has a superior metallic gloss and is suitable for use as a sparkling laminate film 10 for an automobile.

Note that the front surface of the transparent surface substrate 1 of the sparkling laminate film 10 is sometimes covered with a not shown protective substrate for the purpose of preventing scratching during the post-processing steps of the transparent surface substrate or during transport or storage. As this protective substrate, a polyester-based resin film or a polyester-based resin film containing a copolymer ingredient or a polypropylene resin film etc. is used. The protective substrate has a thickness of 9 to 100 μm, more preferably 12 to 75 μm. Under 9 μm, the protective function is not satisfactory, while over 100 μm, the cost is disadvantageous.

### EXAMPLE 1

As the transparent surface substrate 11, a polyester-based film type 1 of a thickness of 50 μm (Tetron film made by Teijin Dupont (see “PET1” of Table 1 showing the main properties)) was used. A 180 Å thick Hastelloy alloy vapor deposited layer 21 was formed by sputtering of a Hastelloy alloy (C-22, main ingredient Ni, Mo 12.5 to 14.5%, Cr 20.0 to 22.5%, W 2.5 to 3.5%, Fe 4 to 6%, etc.) on the anti-slip treated surface, then a 80 Å thick chromium vapor deposited layer 22 was successively continuously formed by sputtering on the Hastelloy alloy vapor deposited layer 21 to obtain a 260 Å thick metal vapor deposited layer 20. Note that the step of formation of the metal vapor deposited layer 20 is based on the example of a vapor deposition apparatus using DC magnetron sputtering shown in FIG. 2. The metal vapor deposited layer 20 was then coated with a binary-curing urethane-based adhesive by a dry laminator which was then dried to form an adhesive layer 14 of a thickness of 4 μm. This assembly was then bonded to the corona discharge treated surface of a polypropylene resin film of a thickness of 150 μm serving as the backing material 15 to thereby prepare the sparkling laminate film 10 of Example 1.

### EXAMPLE 2

The same procedure was followed as in Example 1 to fabricate the sparkling laminate film 10 of Example 2 except for using a polyester-based film type 2 (Tetron film made by Teijin Dupont (see “PET2” in Table 1 showing main properties)) as the transparent surface substrate.

TABLE 1
Main Properties of Transparent Surface Substrate

| Mechanical properties | PET1 | PET2 |
|---|---|---|
| Breaking strength (MPa) | | |
| Vertical | 220 | 220 |
| Horizontal | 210 | 270 |
| Elongation at break (%) | | |
| Vertical | 180 | 120 |
| Horizontal | 170 | 120 |
| F-5 value (stress at 5% elongation) (MPa) | | |
| Vertical | 105 | 115 |
| Horizontal | 100 | 110 |

### EXAMPLE 3

A polyester-based film PET1 of a thickness of 50 μm was used as the transparent surface substrate 11. A 180 Å thick Hastelloy alloy vapor deposited layer 21 was formed by sputtering of a Hastelloy alloy on the anti-slip treated surface, then a 80 Å thick titanium vapor deposited layer 51 was successively continuously formed by sputtering on the Hastelloy alloy vapor deposited layer 50. Note that for the titanium, a known one was used. It is also possible to use a titanium alloy. For the rest of the structure, the same procedure was followed as in Example 1 to fabricate the sparkling laminate film 50. In the figures, the same members are assigned the same reference numerals.

### EXAMPLE 4

The same procedure was followed as in Example 3 to obtain the sparkling laminate film 50 of Example 4 except for using a known polyvinyl chloride (PVC) as the backing material.

### COMPARATIVE EXAMPLE

As a comparative example, a polyester-based film type 2 (Tetron film made by Teijin Dupont (see “PET2” of Table 1 showing main properties)) was used as the transparent surface substrate and a metal vapor deposited layer of only chromium of a thickness of 260 Å was formed on it by sputtering. Note that the step of formation of the chromium vapor deposited layer was based on the example of the vapor deposition apparatus using DC magnetron sputtering shown in FIG. 2. The same procedure was followed as in Example 1 for the rest to obtain the sparkling laminate film of the comparative example.

Next, Examples 1 to 4 and the comparative example will be compared. The evaluated items and methods of evaluation are given below:

Thickness: Average value of thickness in units of μm of five points in width direction measured by a thickness meter (dial gauge)

Initial peeling strength: Average value of interlayer peeling strength of laminate film in units of mN/25 mm width of five points in width direction measured by a sample width of 25 mm, 180° peeling, and a tensile rate of 50 mm/min.

80° C. hot strength: Strength in units of mN/25 mm width measured by method of measurement of initial peeling strength except for measurement at 80° C. atmosphere.

Breaking strength: Average value of breaking strength of five points in width direction measured at a sample width of 25 mm, a chuck distance of 100 mm, and a tensile rate of 50 min/min.

Elongation: Average value of elongation in units of % of five points in width direction measured by a sample width of 25 mm, a chuck distance of 100 mm, and a tensile rate of 50 mm/min.

TABLE 2
Test Results of Hastelloy and Chromium

| | Ex. 1 | Ex. 2 | Comp. Ex. |
|---|---|---|---|
| Total thickness (μm) | 205 | 218 | 209 |
| Initial peeling strength | 21900 | 13580 | 7770 |
| (mN/25 mm width (g/25 mm | (2230) | (1384) | (792) |
| width)) | | | |
| 80° C. hot strength (mN/25 | 8390 | 6320 | 4850 |
| mm width (g/25 mm width)) | (856) | (635) | (495) |
| Breaking strength (MPa | 47.2 | 56.8 | 56.8 |
| (kg/cm²)) | (482) | (579) | (579) |
| Elongation (%) | 156 | 106 | 106 |

As will be understood from Table 2, in Examples 1 and 2 of the present invention, the test results on the initial peeling strength and the 80° C. hot strength are remarkably improved over the comparative example. That is, by successively continuously forming a vapor deposited layer of a Hastelloy alloy and a vapor deposited layer of chromium or chromium alloy on a transparent surface substrate, there is the effect of greatly improving the bonding strength between the transparent surface substrate and the metal vapor deposited layer over a vapor deposited layer of a single metal.

TABLE 3
Test Results of Hastelloy and Titanium

| | Ex. 3 | Ex. 4 | Comp. Ex. |
|---|---|---|---|
| Total thickness (μm) | 216 | 199 | 209 |
| Initial peeling strength | 20780 | 16910 | 7770 |
| (mN/25 mm width (g/25 mm | (2118) | (1724) | (792) |
| width)) | | | |
| 80° C. hot strength (mN/25 | 10880 | 5170 | 4850 |
| mm width (g/25 mm width)) | (1109) | (527) | (495) |
| Breaking strength (MPa | 54.7 | 68.8 | 56.8 |
| (kg/cm²)) | (558) | (701) | (579) |
| Elongation (%) | 159 | 163 | 106 |

Further, as will be understood from Table 3, in Examples 3 and 4 according to the present invention as well, in the same way as Examples 1 and 2, the test results on the initial peeling strength and the 80° C. hot strength are remarkably improved over the comparative example. That is, by successively continuously forming a vapor deposited layer 21 of a Hastelloy alloy and a vapor deposited layer 51 of titanium or titanium alloy on a transparent surface substrate, there is the effect of greatly improving the bonding strength between the transparent surface substrate and the metal vapor deposited layer.

Further, it is learned that even when successively continuously forming a vapor deposited layer 21 of a Hastelloy alloy and a vapor deposited layer 61 of nickel or nickel alloy on a transparent surface substrate, there is the effect of improving the bonding strength between the transparent surface substrate and the metal vapor deposited layer.

Further, in terms of appearance, since the Hastelloy alloy vapor deposited layer 21 first sputtered on the transparent surface substrate 11 is viewed through this, it is possible to give a superior metallic gloss to the appearance.

FIG. 5 shows a shaped article 40 comprised of a shaped article body 41 and the sparkling laminate film 10 (50, 60) integrally bonded to its surface. This shaped article 40 is for example an automobile molding. When extruding the molding body 41, the backing material 15 of the sparkling laminate film 10 (50, 60) and the extruded article are integrally formed. This shaped article 40 exhibits a superior metallic gloss in its appearance and can greatly improve the decorativeness of the product.

Summarizing the effects of the invention, according to the sparkling laminate film of the present invention, it is possible to obtain a novel structure of a sparkling laminate film high in bonding strength between a transparent surface substrate and metal vapor deposited layer and not easily peeling even with long term use while maintaining a superior metallic gloss.

Further, according to the sparkling shaped article using this sparkling film, a tint or gloss can be provided to the appearance and the bonding strength can be improved, so a high quality molding or other shaped article is obtained.

While the invention has been described with reference to specific embodiments chosen for purpose of illustration, it should be apparent that numerous modifications could be made thereto by those skilled in the art without departing from the basic concept and scope of the invention.

What is claimed is:

1. A sparkling laminate film comprised of a transparent surface substrate, a metal vapor deposited layer comprised of a vapor deposited layer of a Hastelloy alloy and a vapor deposited layer of chromium or chromium alloy successively formed on a back surface of said transparent surface substrate, and a backing material integrally laminated with said metal vapor deposited layer through an adhesive layer.

2. A sparkling laminate film comprised of a transparent surface substrate, a metal vapor deposited layer comprised of a vapor deposited layer of a Hastelloy alloy and a vapor deposited layer of titanium or titanium alloy successively formed on a back surface of said transparent surface substrate, and a backing material integrally laminated with said metal vapor deposited layer through an adhesive layer.

3. A sparkling laminate film comprised of a transparent surface substrate, a metal vapor deposited layer comprised of a vapor deposited layer of a Hastelloy alloy and a vapor deposited layer of nickel or nickel alloy successively formed on a back surface of said transparent surface substrate, and a backing material integrally laminated with said metal vapor deposited layer through an adhesive layer.

4. A sparkling laminate film as set forth in any one of claims 1 to 3, wherein said metal vapor deposited layer has a thickness of 150 to 750 Å.

5. A sparkling laminate film as set forth in any one of claims 1 to 3, wherein a hue angle (H°) when measuring the color of said transparent surface substrate is in a range of 245 to 265.

6. A sparkling laminate film as set forth in any one of claims 1 to 3, wherein said transparent surface substrate is a fluorine- or polyester-based film of a thickness of 15 to 100 μm.

7. A sparkling shaped article comprised of a shaped body and a sparkling laminate film as set forth in any one of claims 1 to 3 integrally bonded to a surface of that body.
